(19) United States
(12) Patent Application Publication
(10) Pub. No.: US 2003/0025347 A1
(43) Pub. Date: Feb. 6, 2003

(54) Wheel lifting device

(76) Inventor: Ernie J. Shwaykowski, Shortdale (CA)

Correspondence Address: ADE & COMPANY, 1700-360 MAIN STREET, WINNIPEG, MB, R3C3Z3, CA

(21) Appl. No.: 10/200,292

(22) Filed: Jul. 23, 2002

(30) Foreign Application Priority Data
Aug. 6, 2001 (CA) 2,354,745

(51) Int. Cl. B66C 1/42

(52) U.S. Cl. 294/104

(57) ABSTRACT

A lifting device is provided for lifting a large vehicle wheel and suspending the wheel from a cable. The device includes a main arm including a first hook member arranged to support the rim of the wheel thereon and a cable mount arranged to suspend the wheel from the cable. A support arm is pivotally coupled to the main arm and includes a second hook member mounted thereon confronting the first hook member for grasping the wheel therebetween. The support arm is arranged to extend over the tire of the wheel when the rim of the wheel is supported on the first hook member with the second hook member gripping the tire on the opposite side of the wheel. The support arm is shorter than the main arm and configured for gripping the tire of the wheel. The lifting device is particularly useful for laying large wheels on their respective sides on the ground while permitting the device to be readily secured to and removed from the wheel.

### FIELD OF THE INVENTION

The present invention relates to a lifting device for lifting vehicle wheels.

### BACKGROUND

Earth moving vehicles and the like typically have large wheels. Some of these wheels for example can be in the order of six feet in diameter and 1600 pounds, thus requiring some mechanical assistance for installation and removal from the vehicle to which they belong. The use of clamping devices which are supported from the cable of a crane are known clamping a tire therein and supporting the weight of the tire during handling of the tire.

Some examples of tire lifting devices are found in U.S. Pat. Nos. 5,466,026 to Steiner, 5,344,207 to Grimm, 5,064,334 to Cooley and 4,022,341 to Lindquist. None of these devices however are arranged to lift a large vehicle tire which is supported within a wheel well of the vehicle, nor are these devices suitably arranged to lay the tire on a side of the tire on the ground once it has been removed from the vehicle. Requiring the wheels to be deposited while standing on end is hazardous to workers replacing such wheels due to the considerable size and weight of large vehicle wheels which are not supported in a stable manner when standing on end. Furthermore these devices are generally limited with regard to the varying sizes of tires which can be accommodated due their respective wheel gripping configurations.

### SUMMARY

According to the present invention there is provided a lifting device for lifting a vehicle wheel including a rim and a tire supported on the rim, the device comprising:

a main arm including:

a first hook member projecting from a side of the main arm arranged to support the rim on a first side of the wheel thereon; and

a cable mount spaced from the first hook member arranged to support the main arm on a cable with the first hook member being suspended below the cable mount; and

a support arm pivotally coupled to the main arm and including a second hook member mounted thereon;

the first and second hook members being arranged to confront one another and being movable relative to one another with pivotal movement of the support arm relative to the main arm;

the support arm being arranged to extend over the tire of the wheel when the rim of the wheel is supported on the first hook member with the second hook member being arranged to engage the tire on a second side of the wheel opposite the first hook member.

Locating the cable mount on the main arm permits the lifting device to lift a tire supported within a wheel well if required. Pivotally mounting the support arm on the main arm and arranging the second hook member to grip only the tire permits the hooks to be readily spread apart for reaching over a tire which is either supported on a vehicle or on its side on the ground.

The cable mount is preferably offset laterally from the side of the main arm from which the first hook member projects. The lateral offset is preferably at a fixed spacing from the main arm in a direction in which the first hook member projects from the side of the main arm.

The cable mount may be pivotally mounted on the main arm about a lateral axis of the main arm extending transversely to a direction of the first hook member projecting from the side of the main arm. This assists the lifting device in readily gripping a tire which is laid on its side.

The support arm is preferably pivotal into a released position in which the support arm and the main arm are at an obtuse angle relative to one another between the confronting first and second hooks. This permits the hooks to be readily spread apart for reaching over numerous size tires with ease.

The support arm is preferably shorter than the main arm to assist in stably supporting the wheel while arranging the second hook member to grip only the tire of the wheel which assists the device from being released or attached to a tire laid on its side. In particular, a length of the support arm from the second hook to a point at which the support arm is pivotally mounted on the main arm is preferably shorter that a length of the main arm from the first hook to the point at which the support arm is pivotally mounted on the main arm.

The first hook may project from the side of the main arm outwardly at an incline towards the cable mount.

The first hook member may also be arranged to support an outer rim flange of the rim of the wheel thereon. In this instance, the first hook member preferably includes a support surface which faces the cable mount and is arranged to support the rim thereon, the support surface including a protrusion spaced outwardly from the main arm which projects outwardly from the support surface towards the cable mount for retaining the rim on the support surface.

There may be provided a mounting aperture extending through the main arm adjacent the first hook arranged to receive a fastener therethrough. The mounting aperture would preferably be arranged to be aligned with a bolt hole of a wheel supported on the first hook for securing the main arm to the bolt hole.

There may be provided a stop member which limits pivotal movement of the support arm in relation to the main arm within a prescribed range of motion.

There may provided a sliding member mounted on the main arm for sliding movement in a longitudinal direction of the main arm, the support arm being pivotally mounted on the sliding member. This arrangement assist in accommodating tires having different diameters.

A stop member is preferably mounted on the main arm arranged to restrict sliding movement of the sliding member to a prescribed spacing from the first hook member.

The second hook member may be pivotally mounted on the support arm to assist in releasing the second hook member from the wheel. This is particularly useful when reaching over large tires or when gripping a tire within a wheel well of a vehicle. A stop member is preferably arranged to selectively restrict displacement of a free end of the second hook member away from the support arm in use.

The second hook member preferably includes a plurality of gripping members arranged to grip the tire of the wheel.

The second hook member may comprise a flat plate mounted transversely to a longitudinal direction of the support arm. The plurality of gripping members in this instance are preferably mounted at laterally spaced positions on the flat plate so as to be arranged to grip the tire of the wheel.

### BRIEF DESCRIPTION OF THE DRAWINGS

In the accompanying drawings, which illustrate exemplary embodiments of the present invention:

FIG. 1 is an isometric view of a first embodiment of the lifting device.

FIG. 2 is a side elevational view of the device of FIG. 1 shown suspending a wheel thereon.

FIG. 3 is a side elevational view of the device of FIG. 1 shown with a wheel being laid on its side.

FIG. 4 is an isometric view of a second embodiment of the lifting device.

FIG. 5 is a side elevational view of the device of FIG. 4 shown suspending a wheel thereon.

FIG. 6 is an isometric view of a further embodiment of the second hook member.

### DETAILED DESCRIPTION

Referring to the accompanying drawings, there is illustrated a lifting device generally indicated by reference numeral 10. The device 10 is intended for use in lifting a wheel 12 of a large vehicle, for example earth moving vehicles including mine trucks and the like.

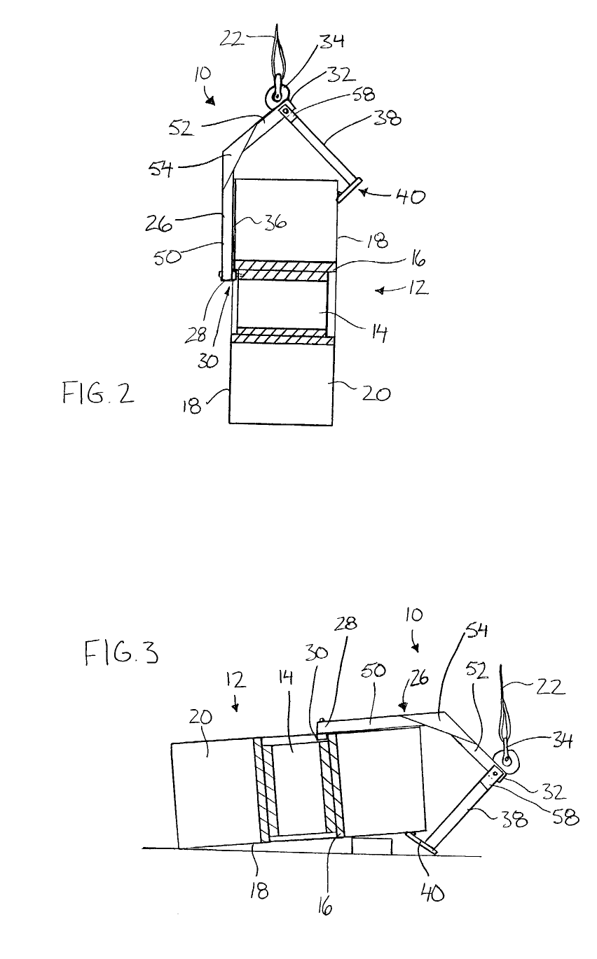

The wheel 12 is generally of the type having a rim 14 with an annular outer rim flange 16 adjacent each side 18 of the wheel. A tire 20 is supported on the rim 14 as in conventional tires. The lifting device 10 is arranged to grip the rim 14 on a first side of the wheel 12 and the tire 20 on a second side of the wheel 12 so as to be arranged to suspend the wheel from the cable 22 of a crane or boom. The device 10 is particularly suited for lifting a wheel 12 off of a vehicle and for laying the wheel on the ground on its side as shown in FIG. 3.

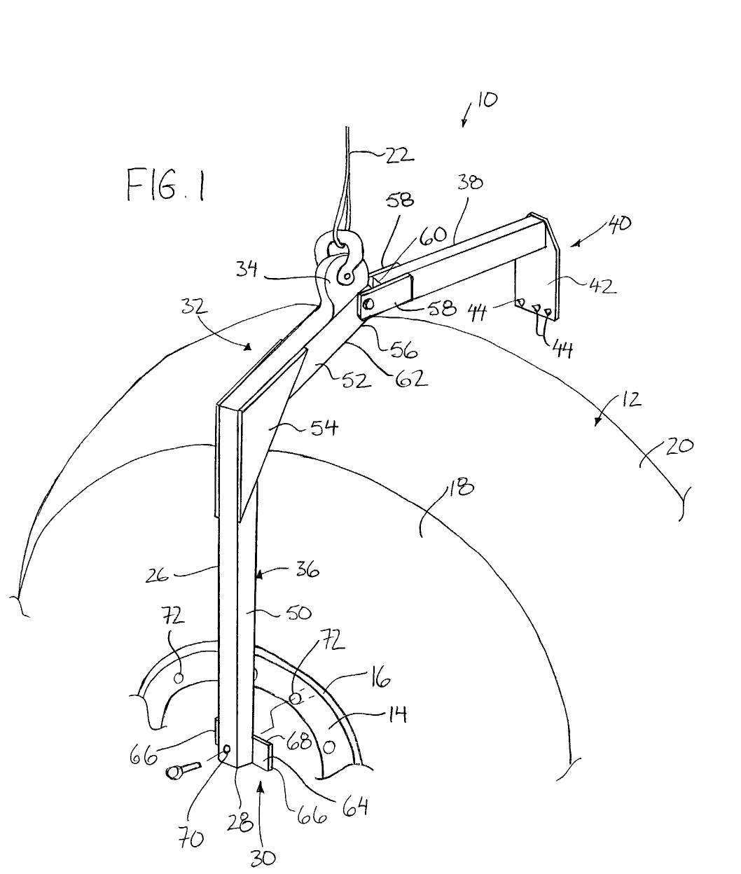

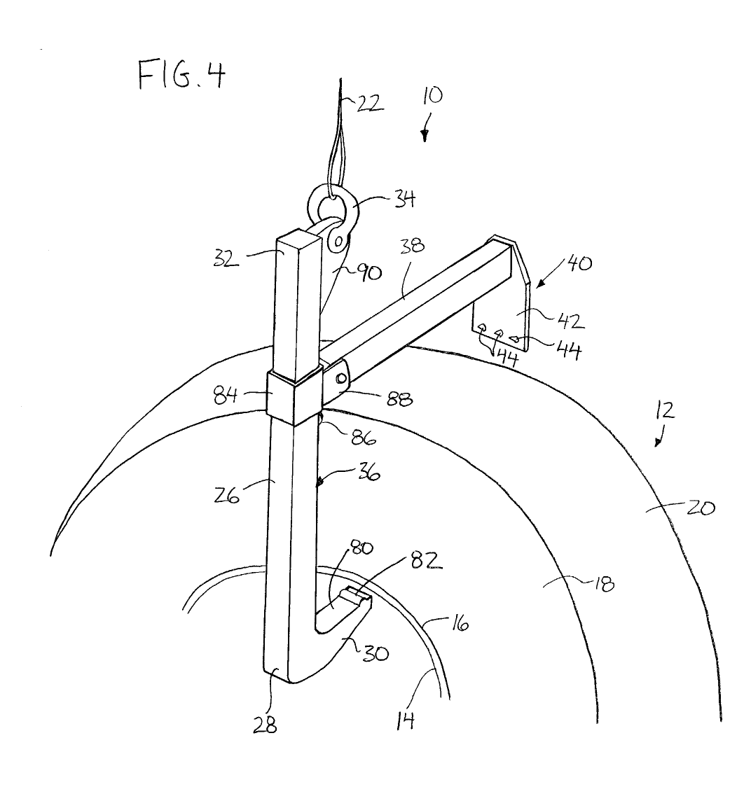

While two embodiments are illustrated in the drawings, FIGS. 1 and 4 respectively, the common elements of the these two embodiments will now be described in the following. The device 10 generally includes a main arm 26 which extends in a longitudinal direction from a bottom end 28 mounting a first hook member 30 thereon to a top end 32 which is arranged to be suspended from a cable mount 34 for hanging from the cable 22 in use. The first hook member 30 is mounted on an inner side 36 of the main arm 26 to project laterally outwardly from the inner side of the main arm. The first hook member is arranged to support the rim 14 of the wheel on a first side of the wheel.

A support arm 38 is provided and arranged for retaining the wheel on the first hook member of the main arm. The support arm 38 is pivotally supported on the main arm 26 at a location spaced upwardly from the first hook member 30 to project laterally outwardly from the main arm 26 from the inner side 36 of the main arm in the same direction that the first hook member projects. The support arm 38 is pivotally supported on the main arm at an inner end of the support arm and mounts a second hook member 40 at a free end thereof.

The first and second hook members 30, 40 are arranged to confront one another and are movable relative to one another with pivotal movement of the support arm relative to the main arm. A length of the support arm 38 as measured from the second hook member 38 at a free end thereof to the point at which the support arm is pivotally supported on the main arm at an inner end of the support arm is arranged to be shorter than a length of the main arm 26 from the first hook member 30 to the same point at which the support arm 38 is pivotally supported thereon. The support arm is thus arranged to engage only over the tire when the first hook member supports the rim of the wheel thereon such that the second hook member engages the tire and not the rim on the opposite side of the wheel. The support arm 38 is arranged to be pivoted into a released position forming an obtuse angle between the support arm and the main arm as measured between the confronting first and second hook members to permit the lifting device to be readily reached over a tire.

The second hook member 40 comprises a broad plate member which is substantially wider than the support arm 38 and is mounted perpendicularly to the support arm 38 at the free end thereof. The broad gripping surface 42 of the hook member 40 faces inwardly towards the main arm 26 so as to be suitably arranged for gripping the side wall of the tire. The gripping surface 42 includes a plurality of gripping members 44 which are laterally spaced across the gripping surface 42 in a direction which is transverse to a plane containing both the main arm and the support arm. The gripping members 44 project outwardly from the gripping surface 42 for engaging the tire in use. The gripping members 44 as illustrated comprise bolts which have been welded to the second hook member 40 to project perpendicularly outwardly from the gripping surface 42. The free ends of the bolts may be tapered or sharpened as desired for enhanced grip.

The cable mount 34 is arranged to be offset laterally from the main longitudinal direction of the main arm 26 from the inner side 36 of the main arm in the same direction which the first hook member 30 projects. The location of the cable mount 34 is rigidly located at a fixed lateral spacing from the main arm 26 above the first hook member 30 and the point at which the support arm 38 is pivotally supported on the main arm.

The cable mount 34 is an annular steel ring arranged to receive the cable 22 therethrough. The cable mount 34 is pivotally coupled to the main arm 26 for pivotal movement about a lateral axis which is perpendicular to both the longitudinal direction of the main arm 26 and the direction from which the first hook member projects from the main arm. The pivotal mounting of the cable mount assists in suspending the device from the cable 22 when laying a tire flat on its side as shown in FIG. 3.

Referring now to FIGS. 1 through 3 a first embodiment of the lifting device 10 will now be described in further detail. In the first embodiment the main arm 26 includes a straight portion 50 and an inclined portion 52. The two portions are each formed of 1¼ inch thick steel stock being welded together at an obtuse angle relative to one another. A gusset 54 is coupled between the two portions for added structural stability. The straight portion 50 extends in the main longitudinal direction of the main arm 26 while the offset portion 52 serves to mount the cable mount 34 thereon at an offset lateral spacing from the main longitudinal direction of the main arm as described above.

The cable mount 34 is mounted at a free end 56 of the offset portion 52 on a top side thereof with the support arm 38 being pivotally mounted on the offset portion of the main arm below the cable mount 34 also at the free end 56 thereof. A pair of mounting plates 58 are mounted on opposing sides of the inner end of the support arm 38 to project outwardly therefrom parallel and spaced apart from one another so as to receive the free end 56 of the offset portion of the main arm therebetween. A suitable fastener is received through co-operating apertures in the two mounting plates 58 and the free end 56 for pivotally coupling the support arm to the main arm.

The inner end 60 of the support arm 38 between the mounting plates 58 is spaced sufficiently close to the free end 56 of the main arm such that the inner end 60 of the support arm engages a bottom side 62 of the offset portion 52 of the main arm when the support 38 is pivoted into an acute angle with the offset portion 52 of the main arm such that the bottom side 62 acts as a stop to restrict pivotal movement of the support arm to a position adjacent the straight portion 50 of the main arm.

In the first embodiment the first hook member 30 generally comprises a rigid plate 64 which is mounted on the inner side 36 of the main arm 26 adjacent the bottom end 28 thereof. The plate 64 defines a pair of flanges 66 projecting laterally outwardly from the main arm 26 parallel to a plane of the inner side 36 of the straight portion 50 of the main arm. A top edge 68 of the rigid plate 64 defines a supporting surface projecting perpendicularly outward from the inner side 36 of the straight portion of the main arm which is particularly suited for supporting the rim flange 16 of large vehicle wheels in the order of 6 feet in diameter thereon.

A mounting aperture 70 extends through the bottom end of at the main arm 26 and the rigid plate 64 perpendicularly to the plate 64 and the inner side 36 of the main arm for receiving the threaded portion of a bolt therethrough. A spacing of the aperture 70 from the top edge 68 of the rigid plate is arranged to correspond with the spacing between the outer rim flange 16 and the bolt holes 72 of a conventional tire used on mine trucks and the like such as the 450 model available by Toro tires. The mounting aperture 70 is thus arranged for alignment with one of the bolt holes 72 when the outer rim flange is supported on the top edge 68 of the rigid plate. Securing a bolt 74 through the mounting aperture 70 and a corresponding bolt hole 72 of the rim of the wheel assists in securing the wheel to the first hook, although the use of the support arm 38 is normally sufficient for retaining the wheel on the first hook member without the additional securement of a bolt being needed.

Turning now to FIGS. 4 and 5 a second embodiment of the lifting device 10 will now be described in further detail. In the second embodiment the main arm 26 comprises a straight bar having the first hook member 30 being formed integrally at a bottom end 28 thereof. The first hook member 30 is arranged to project outwardly from the inner side 30 of the main arm at a slight upward incline towards the cable mount 34 mounted on a top end 32 of the main arm. A supporting surface 80 on a top side of the first hook member 30 which faces the cable mount 34 is arranged to be at approximately 87° from the longitudinal direction of the main arm 26 to assist in retaining the rim of the wheel thereon. A projection 82 is located on the supporting surface 80 spaced from the inner side 36 of the main arm to project outwardly from the supporting surface towards the cable mount thus acting as a retainer member for securing the outer rim flange 16 of the wheel between the projection 82 and the inner side of the main arm.

In the second embodiment a collar 84 is slidably mounted on the main arm 26 for sliding movement in the longitudinal direction of the main arm. Both the collar 84 and the main arm 26 have a mating rectangular cross section to restrict relative pivotal movement of the collar about a longitudinal axis of the main arm. A stop member 86 is mounted on the inner side 36 of the main arm to restrict downward sliding movement of the collar 84 towards the first hook member beyond a spacing which corresponds approximately to the length of the support arm 38.

A pair of spaced apart mounting plates 88 project outwardly from the collar 84 in the same direction as the first hook member from the inner side 36 of the main arm for mounting the support arm 38 at an inner end of the arm thereon. The pair of mounting plates 88 are parallel and spaced apart from one another for receiving the inner end of the support arm 38 therebetween. A set of co-operating apertures through the mounting plates 88 and the inner end of the support arm 38 are arranged to receive a suitable fastener therethrough for pivotally mounting the support arm about a laterally extending axis parallel to the axis of the cable mount 34. The use of the collar 84 ensures that the second embodiment of the lifting device 10 is suitably arranged for lifting tires of various sizes. Depending upon the size of the tire, the position of the collar is automatically adjusted due to the forces acting on the second hook member from the weight of the wheel which primarily act in a longitudinal direction of the support arm to position the collar as required.

The cable mount 34 in the second embodiment is supported on a plate member 90 which projects outwardly from the inner side 36 of the main arm 26 adjacent a top end 32 thereof in the same direction as the first hook member. The plate member 90 is thus suitably arranged for mounting the cable mount 34 thereon at a position which is offset laterally from the longitudinal direction of the main arm as described previously.

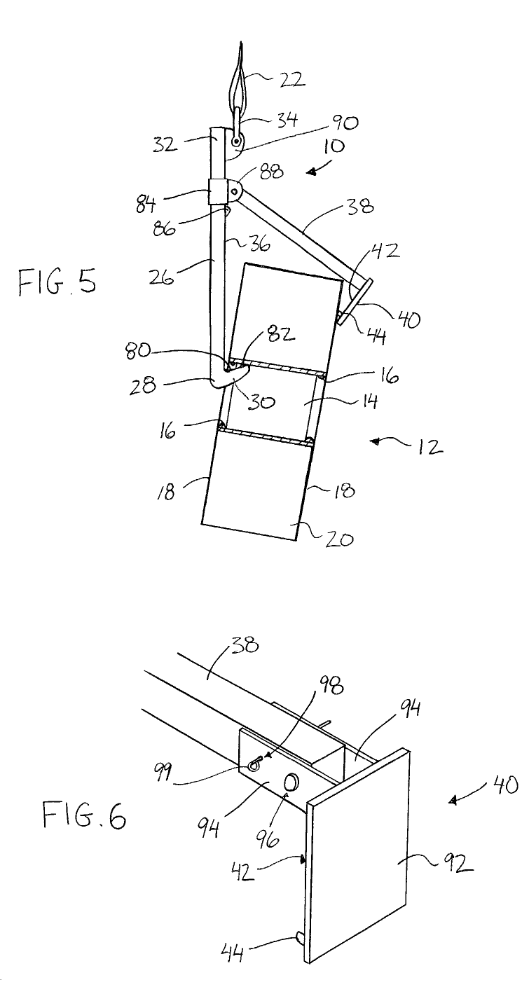

Turning now to FIG. 6 a further embodiment of the second hook member 40 on the free end of the support arm 38 is illustrated. In this arrangement the second hook member 40 comprises a flat plate 92 which is pivotally mounted on the free end of the support 38 for pivotal movement about a laterally extending axis extending perpendicularly to the longitudinal direction of the support arm. The second hook member is thus arranged to be pivotal between a gripping position as shown in FIG. 6 in which the plate 92 lies substantially perpendicularly to the support arm 38 projecting generally downward therefrom so as to confront the first hook member 30 and a released position in which the plate 92 lies in a substantially parallel plane to the longitudinal direction of the support arm 38. The plate 92 is thus pivotal about an axis which lies perpendicularly to a direction in which the second hook member projects for confronting the first hook member.

The plate 92 is mounted to the free end of the support arm 38 by a pair of parallel and spaced apart mounting plates 94 projecting outwardly from the gripping surface 42 of the second hook member so as to receive the free end of the support arm 38 therebetween. A first set of co-operating apertures 96 in the mounting plates 94 and the free end of the support arm 38 are arranged to receive a suitable fastener there though for pivotally mounting the plate onto the support arm for rotation about at longitudinal axis of the fastener. A second set of apertures 98 in the mounting plates 94 and the free end of the support 38 are arranged to co-operate to receive a retainer member 99 there though in the gripping position. The retainer member 99 serves to restrict displacement of the plate 92 away from the main support arm into the released position for adequately gripping a tire in use.

When lifting a tire off of a vehicle the arms of the lifting device 10 are first separated to form an obtuse angle therebetween for reaching over the tire to secure the tire between the first and second confronting hook members. The main arm 26 is arranged to support the weight of the tire while the support arm acts primarily to retain the wheel on the first hook member, but also supports some of the weight of the wheel. When the second hook member is arranged as illustrated in FIG. 6 it may be desirable to remove the retainer member 99 to displace the second hook member into the released position. The released position of the second hook member is particularly useful when it is desired for the support arm to reach over top of a wheel within a wheel well as shown in dotted line in FIG. 5 and there is insufficient clearance for the second hook member in the gripping position of FIG. 6. Once the support arm 38 is positioned to extend over the tire the second hook member is again secured in the gripping position.

Once the arms of the device 10 have been positioned to extend over the wheel, the first hook member is secured adjacent the inner side of the rim 14 while the second hook grips the tire on the opposite side of the wheel using the plural gripping members 44. The wheel can then be lifted using a suitable boom or crane with the cable 22 thereof being attached to the cable mount 34. The tire can then be laid flat on a side thereof corresponding to the side upon which the second hook member grips the tire by simply lowering the tire until the tire touches the ground and then by moving the lifting device in the direction which the inner side 36 of the main arm of the lifting device faces. As the bottom end of the tire grips the ground the cable mount 34 will pivot about its axis as the tire is lowered into a lying position as shown in FIG. 3.

Positioning a block on the ground in alignment with an upper portion of the tire provides sufficient clearance for the second hook member when the tire is resting on the ground to permit the second hook member to be readily released for attachment to another tire on the ground. For lifting the tire from the ground the reverse steps are accomplished until a new tire is mounted on the vehicle.

Releasing the device from a tire on a vehicle requires simply removing tension from the cable 22 so that the support arm 38 may be lifted over the tire manually at which point the device becomes released from the tire. In the instance where a tire is located within a wheel well it may be required to release the plate 92 of the second hook member 40 by removing the retainer member 99. In some embodiments it may also be required to remove the bolt from the first hook member 30 which secured the first hook member to the rim of the wheel.

While various embodiments of the present invention have been described in the foregoing, it is to be understood that other embodiments are possible within the scope of the invention. The invention is to be considered limited solely by the scope of the appended claims.

1. A lifting device for lifting a vehicle wheel including a rim and a tire supported on the rim, the device comprising:
a main arm including:
a first hook member projecting from a side of the main arm arranged to support the rim on a first side of the wheel thereon; and
a cable mount spaced from the first hook member arranged to support the main arm on a cable with the first hook member being suspended below the cable mount; and
a support arm pivotally coupled to the main arm and including a second hook member mounted thereon;
the first and second hook members being arranged to confront one another and being movable relative to one another with pivotal movement of the support arm relative to the main arm;
the support arm being arranged to extend over the tire of the wheel when the rim of the wheel is supported on the first hook member with the second hook member being arranged to engage the tire on a second side of the wheel opposite the first hook member.

2. The device according to claim 1 wherein the cable mount is offset laterally from the side of the main arm from which the first hook member projects.

3. The device according to claim 2 wherein the cable mount is offset laterally at a fixed spacing from the main arm in a direction in which the first hook member projects from the side of the main arm.

4. The device according to claim 1 wherein the cable mount is pivotally mounted on the main arm about a lateral axis of the main arm extending transversely to a direction of the first hook member projecting from the side of the main arm.

5. The device according to claim 1 wherein the support arm is pivotal into a released position in which the support arm and the main arm are at an obtuse angle relative to one another between the confronting first and second hooks.

6. The device according to claim 1 wherein the support arm is shorter than the main arm.

7. The device according to claim 1 wherein a length of the support arm from the second hook to a point at which the support arm is pivotally mounted on the main arm is shorter that a length of the main arm from the first hook to the point at which the support arm is pivotally mounted on the main arm.

8. The device according to claim 1 wherein the first hook projects from the side of the main arm outwardly at an incline towards the cable mount.

9. The device according to claim 1 wherein the first hook member is arranged to support an outer rim flange of the rim of the wheel thereon.

10. The device according to claim 9 wherein the first hook member includes a support surface which faces the cable mount and is arranged to support the rim thereon, the support surface including a protrusion spaced outwardly from the main arm which projects outwardly from the support surface towards the cable mount for retaining the rim on the support surface.

11. The device according to claim 1 wherein there is provided a mounting aperture extending through the main arm adjacent the first hook arranged to receive a fastener therethrough, the mounting aperture being arranged to be aligned with a bolt hole of a wheel supported on the first hook for securing the main arm to the bolt hole.

12. The device according to claim 1 wherein there is provided a stop member which limits pivotal movement of the support arm in relation to the main arm within a prescribed range of motion.

13. The device according to claim 1 wherein there is provided a sliding member mounted on the main arm for sliding movement in a longitudinal direction of the main arm, the support arm being pivotally mounted on the sliding member.

14. The device according to claim 13 wherein there is provided a stop member mounted on the main arm arranged to restrict sliding movement of the sliding member to a prescribed spacing from the first hook member.

15. The device according to claim 1 wherein the second hook member is pivotally mounted on the support arm.

16. The device according to claim 15 there is provided a stop member arranged to selectively restrict displacement of a free end of the second hook member away from the support arm.

17. The device according to claim 1 wherein the second hook member includes a plurality of gripping members arranged to grip the tire of the wheel.

18. The device according to claim 1 wherein the second hook member comprises a flat plate mounted transversely to a longitudinal direction of the support arm.

19. The device according to claim 18 wherein there is provided a plurality of gripping members mounted at laterally spaced positions on the flat plate arranged to grip the tire of the wheel.
